(19) United States
(12) Patent Application Publication
(10) Pub. No.: US 2017/0127239 A1
(43) Pub. Date: May 4, 2017

(54) METHOD AND APPARATUS FOR FORMING BANK OF INFORMATION

(71) Applicant: Spreadtrum Hong Kong Limited, Kowloon (CN)

(72) Inventor: Samuli Heikkinen, Zhangjiang (CN)

(21) Appl. No.: 14/925,141

(22) Filed: Oct. 28, 2015

(51) Int. Cl. H04W 4/02; H04J 11/00; H04W 48/16; H04B 7/185; H04W 4/00

(52) U.S. Cl. CPC H04W 4/028; H04B 7/18556; H04W 4/003; H04W 48/16; H04J 11/0083; H04W 84/042

(57) ABSTRACT

The embodiments of the present disclosure provide a method for forming a bank of information, where the method includes: obtaining a set of information; and forming a bank of information based on the set of information, wherein the bank of information at least comprises a first set of geographic information. Furthermore, the embodiments of the present disclosure further provide an apparatus for forming a bank of information. By using the bank of information, a scope of a mobile network search is narrowed because only a part of bands or a part of systems may be searched. Accordingly, forming the bank of information contributes to avoiding searching all systems and all bands so as to save time for the mobile network search.

### TECHNICAL FIELD

The present disclosure generally relates to telecommunications, and more particularly, to a method and an apparatus for forming a bank of information.

### BACKGROUND

Nowadays, mobile devices (e.g. cell phones, touch pads, etc.) typically support many systems (e.g. Global System for Mobile communications (GSM), Wideband Code Division Multiple Access (WCDMA), Time Division-Synchronous Code Division Multiple Access (TD-SCDMA), Long Term Evolution (LTE), etc), and each of the systems generally includes many bands such as bands 2, 25, 41, etc., each of which is a set of continuous frequencies. Thus, searching all systems and all bands for selecting a Public Land Mobile Network (PLMN) with a highest priority is time consuming Conventionally, if a Registered PLMN (RPLMN) or Home PLMN (HPLMN) is available, the RPLMN or the HPLMN is allowed to be selected by the mobile devices for avoiding searching all systems and all bands. However, in some cases, neither the RPLMN nor the HPLMN is available, thus all systems and all bands have to be searched.

### SUMMARY

Regarding to the problem addressed in the background, embodiments of the present disclosure provide a method for forming a bank of information, where the method may include: obtaining a set of information; and forming a bank of information based on the set of information, wherein the bank of information may at least include a first set of geographic information.

In some embodiments, the bank of information may be selected from a group including but being not limited to: a first set of system information, a first set of band information and a first set of frequency information.

In some embodiments, the set of information may be selected from a group including but being not limited to: a second set of geographic information, a second set of system information, a second set of band information and a second set of frequency information.

In some embodiments, forming a bank of information based on the set of information that may include: initiating the bank of information based on the set of information.

In some embodiments, initiating the bank of information based on the set of information that may include: initiating the bank of information based on the set of information using an application.

In some embodiments, forming a bank of information based on the set of information that may include: updating the bank of information based on the set of information.

In some embodiments, updating the bank of information based on the set of information that may include: updating the bank of information based on the set of information using a protocol.

In some embodiments, updating the bank of information based on the set of information that may include: updating the bank of information based on the set of information using an application.

The embodiments of the present disclosure further provide an apparatus for forming a bank of information, where the method may include: at least one processor configured for obtaining a set of information; and forming a bank of information based on the set of information, wherein the bank of information at least may include a first set of geographic information.

In some embodiments, the bank of information may be selected from a group including but being not limited to: a first set of system information, a first set of band information and a first set of frequency information.

In some embodiments, the set of information may be selected from a group including but being not limited to: a second set of geographic information, a second set of system information, a second set of band information and a second set of frequency information.

In some embodiments, at least one processor configured for forming a bank of information based on the set of information that may include: the at least one processor configured for initiating the bank of information based on the set of information.

In some embodiments, the at least one processor configured for initiating the bank of information based on the set of information that may include: the at least one processor configured for initiating the bank of information based on the set of information using an application.

In some embodiments, at least one processor configured for forming a bank of information based on the set of information that may include: the at least one processor configured for updating the bank of information based on the set of information.

In some embodiments, the at least one processor configured for updating the bank of information based on the set of information that may include: the at least one processor configured for updating the bank of information based on the set of information using a protocol.

In some embodiments, the at least one processor configured for updating the bank of information based on the set of information that may include: the at least one processor configured for updating the bank of information based on the set of information using an application.

### BRIEF DESCRIPTION OF THE DRAWINGS

For better clarifying embodiments of the present disclosure, a brief description of drawings needed for describing the embodiments is provided. Obviously, the drawings which follow are the embodiments of the present disclosure. By taking efforts with creativity, those skilled in the art can acquire other drawings based on the drawings provided.

FIG. 1 schematically illustrates a flow diagram presenting an implementation using the method for forming a bank of information according to one embodiment in the present disclosure;

FIG. 2 schematically illustrates a flow diagram presenting an implementation using the method for forming a bank of information according to another embodiment in the present disclosure;

FIG. 3 schematically illustrates a flow diagram presenting an implementation using the method for forming a bank of information according to another embodiment in the present disclosure; and

FIG. 4 schematically illustrates a flow diagram presenting an implementation using the method for forming a bank of information according to another embodiment in the present disclosure.

### DETAILED DESCRIPTION

With respect to the problem addressed in the background, the inventor discovers that, an apparatus may perform a mobile network search using a bank of information so that a scope of the mobile network search may be narrowed because only a part of bands or a part of systems may be searched. Therefore, forming the bank of information may contribute to avoiding searching all systems and all bands so as to save time for the mobile network search.

In order to clarify the objects, characteristics and advantages of the present disclosure, embodiments of the present disclosure will be described in detail in conjunction with the accompanying drawings. However, in certain instances, well known or conventional details are not described in order to avoid obscuring the description of the inventive concepts set forth in the embodiments described herein. References to “one embodiment,” “an embodiment,” “another embodiment,” “yet another embodiment,” or their respective variations in the present disclosure are not necessarily references to the same embodiment; and, such references mean at least one.

The embodiments of the present disclosure provide a method for forming a bank of information. The method may include:
obtaining a set of information; and
forming a bank of information based on the set of information, wherein the bank of information may include a first set of geographic information.

Specifically, the first set of geographic information may include but be not limited to: a country code such as a Mobile Country Code (MCC), or a GPS coordinate.

Specifically, the bank of information may further include: a first set of system information, a first set of band information or a first set of frequency information. Wherein, the first set of system information may include at least one system, where the at least one system is selected from a group including but being not limited to: GSM, WCDMA, TD-SCDMA and LTE. Wherein, the first set of band information may include at least one band, where the at least one band is selected from a group of bands defined by the 3rd Generation Partnership Project (3GPP) or any other standard. Wherein, the first set of frequency information may include at least one frequency.

Specifically, the set of information may include: a second set of geographic information, a second set of system information, a second set of band information or a second set of frequency information. Wherein, the second set of geographic information may include but be not limited to: the country code such as MCC, or the GPS coordinate. Wherein, the second set of system information may include at least one system, where the at least one system is selected from a group including but being not limited to: GSM, WCDMA, TD-SCDMA and LTE. Wherein, the second set of band information may include at least one band, where the at least one band is selected from a group of the bands defined by 3GPP or any other standard. Wherein, the second set of frequency information may include at least one frequency.

Specifically, the set of information may be obtained from a group including but being not limited to: a set of factory setting information, a set of historical information, a set of information received from a satellite and a set of information received from a previously connected network. Wherein, the set of factory setting information may be a set of pre-stored information provided by a component manufacturer or a device vendor. Wherein, the set of historical information may include: at least one MCC, at least one system, at least one band or at least one frequency; the set of historical information may be available in at least one country visited previously. Wherein, the set of information received from a satellite may include but be not limited to: the GPS coordinate. Wherein, due to different mobile networks may be provided by different service providers who may support different systems or use different bands, the set of information received from a previously connected network may contribute to forming the bank of information.

Specifically, the embodiments of the present disclosure do not impose any limitation to a storage medium in which the bank of information is stored.

In some embodiments, the bank of information may be stored in a non-transitory storage medium. Wherein, the non-transitory storage medium may be selected from a group including but being not limited to: a Read-Only Memory (ROM), a Random Access Memory (RAM), a flash memory, an Erasable Programmable ROM (EPROM), an Electrically Erasable Programmable ROM (EEPROM), a circuit card, a magnetic card, an optical card and any type of disk including a floppy disk, an optical disk, a Compact Disc-ROM (CD-ROM) and a magnetic-optical disk.

In some embodiments, the bank of information may be stored in a circuit card where, the circuit card may include: a Universal Integrated Circuit Card (UICC) or a Universal Subscriber Identity Module (USIM).

Further, in some embodiments, the bank of information may be included in a set of software.

Specifically, at least one processor (e.g. CPU, microprocessor, etc) is required for performing the step of the method that forming the bank of information based on the set of information.

In some embodiments, forming the bank of information based on the set of information may include initiating the bank of information based on the set of information. Wherein, if the bank of information is empty, a step that initiating the bank of information based on the set of information may be performed. For example, the step that initiating the bank of information based on the set of information is performed after the bank of information has been created but without initiation. There are a plenty of mechanisms available for initiating the bank of information based on the set of information. The embodiments of the present disclosure do not impose any limitation to the mechanism used for initiating the bank of information based on the set of information.

In some embodiments, forming the bank of information based on the set of information may include initiating the bank of information based on the set of information. Wherein, if the bank of information is empty, a step that initiating the bank of information based on the set of information may be performed. Wherein, initiating the bank of information based on the set of information may include initiating the bank of information based on the set of information using an application, where the application may include but be not limited to: a component manufacturer specific application, a device vendor specific application, a mobile service operator specific application or a commercial application.

In some embodiments, forming the bank of information based on the set of information may include updating the bank of information based on the set of information. Wherein, a step that updating the bank of information based on the set of information may be performed after the bank of information has been initiated. There are a plenty of mechanisms available for updating the bank of information based on the set of information. The embodiments of the present disclosure do not impose any limitation to the mechanism used for updating the bank of information based on the set of information.

In some embodiments, forming the bank of information based on the set of information may include updating the bank of information based on the set of information. Wherein, a step that updating the bank of information based on the set of information may be performed after the bank of information has been initiated. Wherein, updating the bank of information based on the set of information may include updating the bank of information based on the set of information using an application, where the application may include but be not limited to: a mobile service operator specific application or a commercial application.

In some embodiments, forming the bank of information based on the set of information may include updating the bank of information based on the set of information. Wherein, a step that updating the bank of information based on the set of information may be performed after the bank of information has been initiated. Wherein, updating the bank of information based on the set of information may include updating the bank of information based on the set of information using a mobile device updating protocol. There are various mobile device updating protocols available for updating the bank of information based on the set of information. The embodiments of the present disclosure do not impose any limitation to the mobile device updating protocol for updating the bank of information based on the set of information.

In some embodiments, forming the bank of information based on the set of information may include updating the bank of information based on the set of information. Wherein, a step that updating the bank of information based on the set of information may be performed after the bank of information has been initiated. Wherein, updating the bank of information based on the set of information may include updating the bank of information based on the set of information using an Over-The-Air (OTA) protocol.

In some embodiments, forming the bank of information based on the set of information may include updating the bank of information based on the set of information. Wherein, a step that updating the bank of information based on the set of information may be performed after the bank of information has been initiated. Wherein, updating the bank of information based on the set of information may include updating the bank of information based on the set of information using an Open-Mobile-Alliance (OMA) standard protocol.

In some embodiments, forming the bank of information based on the set of information may include updating the bank of information based on the set of information. Wherein, a step that updating the bank of information based on the set of information may be performed after the bank of information has been initiated. Wherein, updating the bank of information based on the set of information may include updating the bank of information based on the set of information using an internet protocol. There are various internet protocols available for updating the bank of information based on the set of information. The embodiments of the present disclosure do not impose any limitation to the internet protocol used for updating the bank of information based on the set of information.

In some embodiments, forming the bank of information based on the set of information may include updating the bank of information based on the set of information. Wherein, a step that updating the bank of information based on the set of information may be performed after the bank of information has been initiated. Wherein, updating the bank of information based on the set of information may include updating the bank of information based on the set of information using a Transmission Control Protocol (TCP).

In some embodiments, forming the bank of information based on the set of information may include updating the bank of information based on the set of information. Wherein, a step that updating the bank of information based on the set of information may be performed after the bank of information has been initiated. Wherein, updating the bank of information based on the set of information may include updating the bank of information based on the set of information using a User Datagram Protocol (UDP).

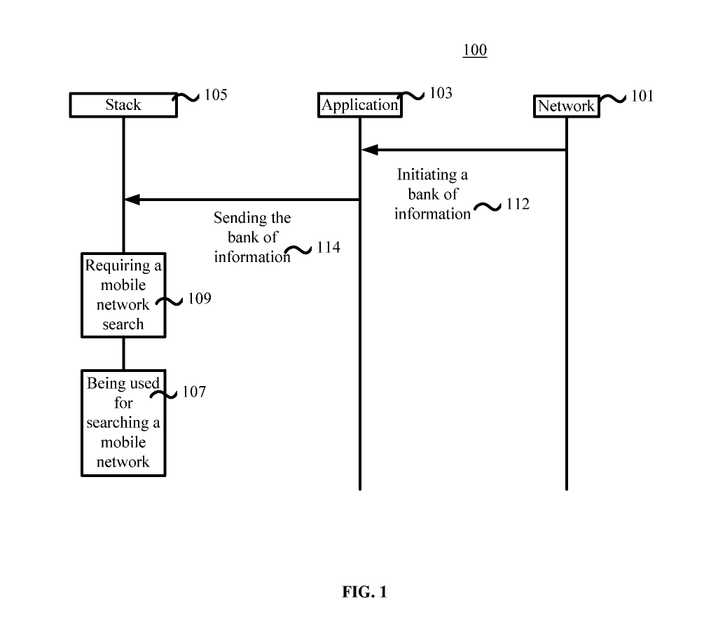

FIG. 1 schematically illustrates a flow diagram presenting an implementation 100 using the method for forming a bank of information according to one embodiment in the present disclosure. The implementation 100 employs an application 103 for initiating a bank of information. The implementation 100 starts from a step 112 that a bank of information in the application 103 is initiated. Specifically, the application 103 may obtain a set of information from a network 101, and then, the bank of information in the application 103 is initiated based on the set of information from the network 101. After performing the step 112, the implementation 100 proceeds to a step 114 that the application 103 sends the bank of information to a stack 105, and the bank of information is stored in the stack 105. After performing the step 114, the implementation 100 proceeds to a step 109 that the stack 105 may require a mobile network search, and then proceeds to a step 107 that the stack 105 may be used for searching a mobile network. Wherein, reasons for requiring a mobile network search may include power up of the stack 105, recovery of coverage, etc.

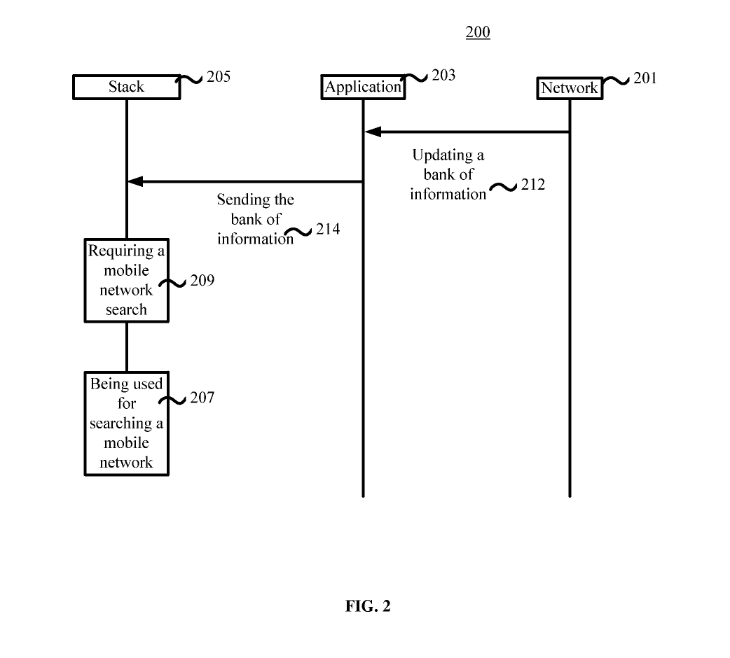

FIG. 2 schematically illustrates a flow diagram presenting an implementation 200 using the method for forming a bank of information according to another embodiment in the present disclosure. The implementation 200 employs an application 203 for updating a bank of information. The implementation 200 starts from a step 212 that a bank of information in the application 203 is updated. Specifically, the application 203 may obtain a set of information from a network 201, and then, the bank of information in the application 203 is updated based on the set of information from the network 201. After performing the step 212, the implementation 200 proceeds to a step 214 that the application 203 sends the bank of information to a stack 205, and the bank of information is stored in the stack 205. After performing the step 214, the implementation 200 proceeds to a step 209 that the stack 205 may require a mobile network search, and then proceeds to a step 207 that the stack 205 may be used for searching a mobile network. Wherein, reasons for requiring a mobile network search may include power up of the stack 205, recovery of coverage, etc.

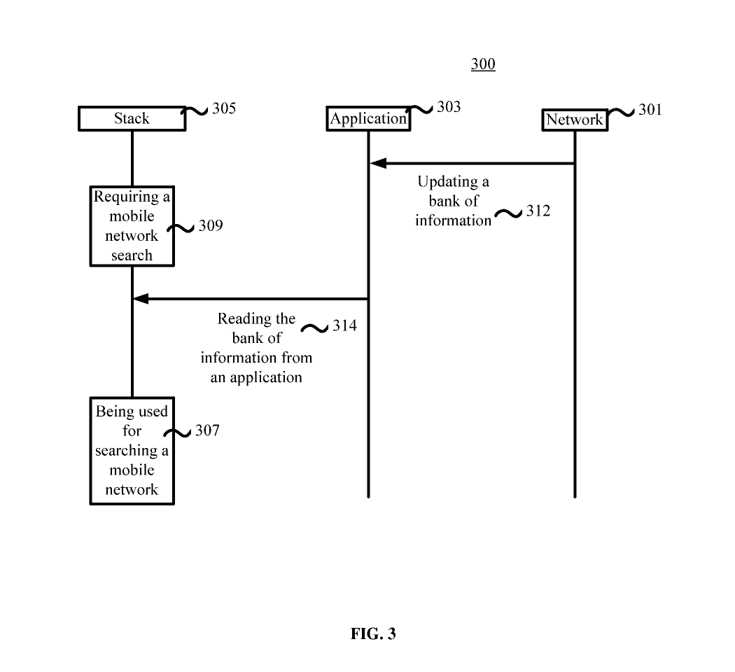

FIG. 3 schematically illustrates a flow diagram presenting an implementation 300 using the method for forming a bank of information according to another embodiment in the present disclosure. The implementation 300 employs an application 303 for updating a bank of information. The implementation 300 starts from a step 312 that a bank of information in the application 303 is updated. Specifically, the application 303 may obtain a set of information from a network 301, and then, the bank of information in the application 303 is updated based on the set of information from the network 301. After performing the step 312, the implementation 300 proceeds to a step 309 that a stack 305 may require a mobile network search, and then, the implementation 300 proceeds to a step 314 that the stack 305 may read the bank of information from the application 303 and then, the stack 305 may store the bank of information. After performing the step 314, the implementation 300 proceeds to a step 307 that the stack 305 may be used for searching a mobile network. Wherein, reasons for requiring a mobile network search may include power up of the stack 305, recovery of coverage, etc.

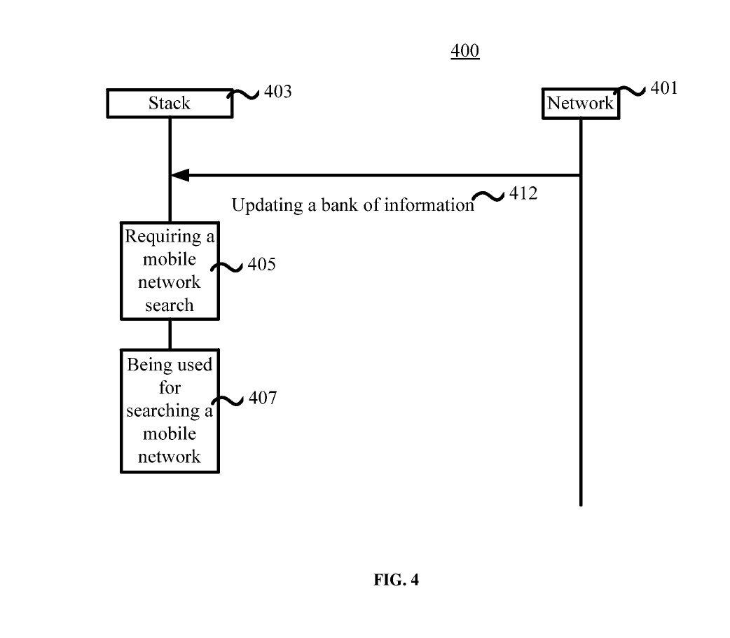

FIG. 4 schematically illustrates a flow diagram presenting an implementation 400 using the method for forming a bank of information according to another embodiment in the present disclosure. The implementation 400 may employ a mobile device updating mechanism for updating a bank of information. The implementation 400 starts from a step 412 that the bank of information stored in a stack 403 is updated, where the stack 403 may be formed in a USIM. Specifically, a set of information is obtained from a network 401, and then, the bank of information stored in the stack 403 is updated based on the set of information from the network 401 using the mobile device updating mechanism. After performing the step 412, the implementation 400 proceeds to a step 405 that the stack 403 may require a mobile network search, wherein reasons for requiring a mobile network search may include power up of the stack 403, recovery of coverage, etc. After performing the step 405, the implementation 400 proceeds to a step 407 that the stack 403 may be used for searching a mobile network.

In some embodiments, referring to FIG. 4, the implementation 400 may employ an OMA standard protocol for updating a bank of information. The implementation 400 starts from a step 412 that the bank of information is updated. Specifically, a set of information is obtained from a network 401, and then, the bank of information stored in a stack 403 is updated based on the set of information from the network 401 using the OMA standard protocol, where the stack 403 may be formed in a USIM. After performing the step 412, the implementation 400 proceeds to a step 405 that the stack 403 may require a mobile network search. After performing the step 405, the implementation 400 proceeds to a step 407 that the stack 403 may be used for searching a mobile network.

In some embodiments, referring to FIG. 4, the implementation 400 may employ an OTA protocol for updating a bank of information. The implementation 400 starts from a step 412 that the bank of information is updated. Specifically, a set of information is obtained from a network 401, and then, the bank of information stored in a stack 403 is updated based on the set of information from the network 401 using the OTA protocol, where the stack 403 may be formed in a USIM. After performing the step 412, the implementation 400 proceeds to a step 405 that the stack 403 may require a mobile network search. After performing the step 405, the implementation 400 proceeds to a step 407 that the stack 403 may be used for searching a mobile network.

Further referring to FIG. 4, in some embodiments, the implementation 400 may employ an internet protocol for updating a bank of information. The implementation 400 starts from a step 412 that the bank of information is updated. Specifically, a set of information is obtained from a network 401, and then, the bank of information stored in a stack 403 is updated based on the set of information from the network 401 using the internet protocol, where the stack 403 may be formed in a USIM. After performing the step 412, the implementation 400 proceeds to a step 405 that the stack 403 may require a mobile network search. After performing the step 405, the implementation 400 proceeds to a step 407 that the stack 403 may be used for searching a mobile network.

In some embodiments, referring to FIG. 4, the implementation 400 may employ a TCP for updating a bank of information. The implementation 400 starts from a step 412 that the bank of information is updated. Specifically, a set of information is obtained from a network 401, and then, the bank of information stored in a stack 403 is updated based on the set of information from the network 401 using the TCP, where the stack 403 may be formed in a USIM. After performing the step 412, the implementation 400 proceeds to a step 405 that the stack 403 may require a mobile network search. After performing the step 405, the implementation 400 proceeds to a step 407 that the stack 403 may be used for searching a mobile network.

In some embodiments, referring to FIG. 4, the implementation 400 may employ a UDP for updating a bank of information. The implementation 400 starts from a step 412 that the bank of information is updated. Specifically, a set of information is obtained from a network 401, and then, the bank of information stored in a stack 403 is updated based on the set of information from the network 401 using the UDP, where the stack 403 may be formed in a USIM. After performing the step 412, the implementation 400 proceeds to a step 405 that the stack 403 may require a mobile network search. After performing the step 405, the implementation 400 proceeds to a step 407 that the stack 403 may be used for searching a mobile network.

The embodiments of the present disclosure provide an apparatus for forming a bank of information. The apparatus may include:
at least one processor configured for:
obtaining a set of information; and
forming a bank of information based on the set of information, wherein the bank of information may include a first set of geographic information.

Specifically, the first set of geographic information may include but be not limited to: a country code such as MCC, or a GPS coordinate.

Specifically, the bank of information may further include: a first set of system information, a first set of band information or a first set of frequency information. Wherein, the first set of system information may include at least one system, where the at least one system is selected from a group including but being not limited to: GSM, WCDMA, TD-SCDMA and LTE. Wherein, the first set of band information may include at least one band, where the at least one band is selected from a group of bands defined by 3GPP or any other standard. Wherein, the first set of frequency information may include at least one frequency.

Specifically, the set of information may include: a second set of geographic information, a second set of system information, a second set of band information or a second set of frequency information. Wherein, the second set of geographic information may include but be not limited to: the country code such as MCC, or the GPS coordinate. Wherein, the second set of system information may include at least one system, where the at least one system is selected from a group including but being not limited to: GSM, WCDMA, TD-SCDMA and LTE. Wherein, the second set of band information may include at least one band, where the at least one band is selected from a group of the bands defined by 3GPP or any other standard. Wherein, the second set of frequency information may include at least one frequency.

Specifically, the set of information may be obtained from a group including but being not limited to: a set of factory setting information, a set of historical information, a set of information received from a satellite and a set of information received from a previously connected network. Wherein, the set of factory setting information may be a set of pre-stored information provided by a component manufacturer or a device vendor. Wherein, the set of historical information may include: at least one MCC, at least one system, at least one band or at least one frequency; the set of historical information may be available in at least one country visited previously. Wherein, the set of information received from a satellite may include but be not limited to: the GPS coordinate. Wherein, due to different mobile networks may be provided by different service providers who may support different systems or use different bands, the set of information received from a previously connected network may contribute to forming the bank of information.

Specifically, the embodiments of the present disclosure do not impose any limitation to a storage medium in which the bank of information is stored.

In some embodiments, the bank of information may be stored in a non-transitory storage medium. Wherein, the non-transitory storage medium may be selected from a group including but being not limited to: a Read-Only Memory (ROM), a Random Access Memory (RAM), a flash memory, an Erasable Programmable ROM (EPROM), an Electrically Erasable Programmable ROM (EEPROM), a circuit card, a magnetic card, an optical card and any type of disk including a floppy disk, an optical disk, a Compact Disc-ROM (CD-ROM) and a magnetic-optical disk.

In some embodiments, the bank of information may be stored in a circuit card where, the circuit card may include: a Universal Integrated Circuit Card (UICC) or a Universal Subscriber Identity Module (USIM).

Further, in some embodiments, the bank of information may be included in a set of software.

Specifically, at least one processor (e.g. CPU, microprocessor, etc) is required for performing the step of the method that forming the bank of information based on the set of information.

In some embodiments, the at least one processor configured for forming the bank of information based on the set of information may include: the at least one processor configured for initiating the bank of information based on the set of information. Wherein, if the bank of information is empty, a step that initiating the bank of information based on the set of information may be performed. There are a plenty of mechanisms available for initiating the bank of information based on the set of information. The embodiments of the present disclosure do not impose any limitation to the mechanism used for initiating the bank of information based on the set of information.

In some embodiments, the at least one processor configured for forming the bank of information based on the set of information may include: the at least one processor configured for initiating the bank of information based on the set of information. Wherein, if the bank of information is empty, a step that initiating the bank of information based on the set of information may be performed. Wherein, initiating the bank of information based on the set of information may include initiating the bank of information based on the set of information using an application, where the application may include but be not limited to: a component manufacturer specific application, a device vendor specific application, a mobile service operator specific application or a commercial application.

In some embodiments, the at least one processor configured for forming the bank of information based on the set of information may include: the at least one processor configured for updating the bank of information based on the set of information. Wherein, a step that updating the bank of information based on the set of information may be performed after the bank of information has been initiated. There are a plenty of mechanisms available for updating the bank of information based on the set of information. The embodiments of the present disclosure do not impose any limitation to the mechanism used for updating the bank of information based on the set of information.

In some embodiments, the at least one processor configured for forming the bank of information based on the set of information may include: the at least one processor configured for updating the bank of information based on the set of information. Wherein, a step that updating the bank of information based on the set of information may be performed after the bank of information has been initiated. Wherein, updating the bank of information based on the set of information may include updating the bank of information based on the set of information using an application, where the application may include but be not limited to: a mobile service operator specific application or a commercial application.

In some embodiments, the at least one processor configured for forming the bank of information based on the set of information may include: the at least one processor configured for updating the bank of information based on the set of information. Wherein, a step that updating the bank of information based on the set of information may be performed after the bank of information has been initiated. Wherein, updating the bank of information based on the set of information may include updating the bank of information based on the set of information using a mobile device updating protocol. There are various mobile device updating protocols available for updating the bank of information based on the set of information. The embodiments of the present disclosure do not impose any limitation to the mobile device updating protocol for updating the bank of information based on the set of information.

In some embodiments, the at least one processor configured for forming the bank of information based on the set of information may include: the at least one processor configured for updating the bank of information based on the set of information. Wherein, a step that updating the bank of information based on the set of information may be performed after the bank of information has been initiated. Wherein, updating the bank of information based on the set of information may include updating the bank of information based on the set of information using an Over-The-Air (OTA) protocol.

In some embodiments, the at least one processor configured for forming the bank of information based on the set of information may include: the at least one processor configured for updating the bank of information based on the set of information. Wherein, a step that updating the bank of information based on the set of information may be performed after the bank of information has been initiated. Wherein, updating the bank of information based on the set of information may include updating the bank of information based on the set of information using an Open-Mobile-Alliance (OMA) standard protocol.

In some embodiments, at least one processor configured for forming the bank of information based on the set of information may include: the at least one processor configured for updating the bank of information based on the set of information. Wherein, a step that updating the bank of information based on the set of information may be performed after the bank of information has been initiated. Wherein, updating the bank of information based on the set of information may include updating the bank of information based on the set of information using an internet protocol. There are various internet protocols available for updating the bank of information based on the set of information. The embodiments of the present disclosure do not impose any limitation to the internet protocol used for updating the bank of information based on the set of information.

In some embodiments, at least one processor configured for forming the bank of information based on the set of information may include: the at least one processor configured for updating the bank of information based on the set of information. Wherein, a step that updating the bank of information based on the set of information may be performed after the bank of information has been initiated. Wherein, updating the bank of information based on the set of information may include updating the bank of information based on the set of information using a Transmission Control Protocol (TCP).

In some embodiments, at least one processor configured for forming the bank of information based on the set of information may include: the at least one processor configured for updating the bank of information based on the set of information. Wherein, a step that updating the bank of information based on the set of information may be performed after the bank of information has been initiated. Wherein, updating the bank of information based on the set of information may include updating the bank of information based on the set of information using a User Datagram Protocol (UDP).

Although the present disclosure has been disclosed above with reference to preferred embodiments thereof, it should be understood by those skilled in the art that various changes may be made without departing from the spirit or scope of the disclosure. Accordingly, the present disclosure is not limited to the embodiments disclosed.

What is claimed is:

1. A method for forming a bank of information, comprising:
obtaining a set of information; and
forming a bank of information based on the set of information, wherein the bank of information at least comprises a first set of geographic information.

2. The method according to claim 1, wherein the bank of information is selected from a group comprising: a first set of system information, a first set of band information and a first set of frequency information.

3. The method according to claim 1, wherein the set of information is selected from a group comprising: a second set of geographic information, a second set of system information, a second set of band information and a second set of frequency information.

4. The method according to claim 1, wherein the set of information is obtained from a group comprising: a set of factory setting information, a set of historical information, a set of information received from a satellite and a set of information received from a previously connected network.

5. The method according to claim 1, wherein the bank of information is stored in a non-transitory storage medium.

6. The method according to claim 1, wherein forming a bank of information based on the set of information that comprises: initiating the bank of information based on the set of information.

7. The method according to claim 6, wherein initiating the bank of information based on the set of information that comprises: initiating the bank of information based on the set of information using an application.

8. The method according to claim 1, wherein forming a bank of information based on the set of information that comprises: updating the bank of information based on the set of information.

9. The method according to claim 8, wherein updating the bank of information based on the set of information that comprises: updating the bank of information based on the set of information using a protocol.

10. The method according to claim 8, wherein updating the bank of information based on the set of information that comprises: updating the bank of information based on the set of information using an application.

11. An apparatus for forming a bank of information, comprising:
at least one processer configured for:
obtaining a set of information; and
forming a bank of information based on the set of information, wherein the bank of information at least comprises a first set of geographic information.

12. The apparatus according to claim 11, wherein the bank of information is selected from a group comprising: a first set of system information, a first set of band information and a first set of frequency information.

13. The apparatus according to claim 11, wherein the set of information is selected from a group comprising: a second set of geographic information, a second set of system information, a second set of band information and a second set of frequency information.

14. The apparatus according to claim 11, wherein the set of information is obtained from a group comprising: a set of factory setting information, a set of historical information, a set of information received from a satellite and a set of information received from a previously connected network.

15. The apparatus according to claim 11, wherein the bank of information is stored in a non-transitory storage medium.

16. The apparatus according to claim 11, wherein the at least one processer is configured for forming a bank of information based on the set of information comprises: the at least one processer is configured for initiating the bank of information based on the set of information.

17. The apparatus according to claim 16, wherein the at least one processer is configured for initiating the bank of information based on the set of information comprises: the at least one processer is configured for initiating the bank of information based on the set of information using an application.

18. The apparatus according to claim 11, wherein the at least one processer is configured for forming a bank of information based on the set of information comprises: the at least one processer is configured for updating the bank of information based on the set of information.

19. The apparatus according to claim 18, wherein the at least one processer is configured for updating the bank of information based on the set of information comprises: the at least one processer is configured for updating the bank of information based on the set of information using a protocol.

20. The apparatus according to claim 18, wherein the at least one processer is configured for updating the bank of information based on the set of information comprises: the at least one processer is configured for updating the bank of information based on the set of information using an application.
